(19) United States
(12) Patent Application Publication
(10) Pub. No.: US 2008/0059177 A1
(43) Pub. Date: Mar. 6, 2008

(54) ENHANCEMENT OF SIMULTANEOUS MULTI-USER REAL-TIME SPEECH RECOGNITION SYSTEM

(76) Inventors: JAMEY POIRIER, GRAFTON, MA (US); MARK HANEGRAAFF, BROOKLYN, NY (US); DARRELL POIRIER, WOODSTOCK, CT (US)

Correspondence Address: BLODGETT BLODGETT, 43 HIGHLAND STREET, WORCESTER, MA, 016092797, US

(21) Appl. No.: 11/751,017

(22) Filed: May 19, 2007

Related U.S. Application Data
(60) Provisional application No. 60/747,729, filed on May 19, 2006.

(51) Int. Cl. G10L 15/00

(52) U.S. Cl. 704/251; 704/E15.001

(57) ABSTRACT

This invention involves additional details and uses for the invention described in U.S. Pat. No. 7,047,192 Simultaneous Multi-User Real-Time Speech Recognition System file by Poirier. The patent granted to Poirier teaches a platform based on audio events on which can be built larger applications to solve problems of capturing and transcribing human conversations. U.S. Pat. No. 7,047,192 also explains and teaches that indexing, cataloging, editing, and searching audio is possible using a browser to find specific content within text which is then directly linked with the relative audio event. More specifically it describes how this patent can be used as a building block approach to provide functionality for real-time automatic speech recognition systems that a scalable from a single user to hundreds and potentially thousands of users having conversations.

### CROSS-REFERENCE TO RELATED APPLICATIONS

This application claims the benefit under 35 U.S.C. §119(e) of U.S. Provisional Application No. 60/747,729 filed May 19, 2007, which is hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves the field of computerized speech recognition.

### BACKGROUND OF THE INVENTION

In overview, Poirier' U.S. Pat. No. 7,047,192 teaches a system that converts an audio stream into 2 audio streams, then passes the first audio stream to a speech recognition converter and passes the second audio stream to a medium. One of the audio streams is divided into events as described in Poirier's invention. The audio events are then indexed to match their relative text created through speech recognition. The events are then indexed and cataloged to make up a Multi-user Voice Log on MVL. The Multi-user Voice Logs are then stored on disk drives as files that can then be viewed by a MVL Browser that can display, search, sort, edit, and playback the audio events. Prior art systems for speech recognition have generally been inefficient, accurate, and overly complex to use.

These and other difficulties experienced with the prior art devices have been obviated in a novel manner by various embodiments of the present invention.

It is, therefore, an outstanding object of some embodiments of the present invention to provide a speech recognition system that efficiently and effectively recognizes speech.

It is a further object of some embodiments of the invention to provide a speech recognition system that is capable of being manufactured of high quality and at a low cost, and which is capable of providing a long and useful life with a minimum of maintenance.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF THE INVENTION

This invention involves additional details and uses for the invention described in U.S. Pat. No. 7,047,192 Simultaneous Multi-User Real-Time Speech Recognition System file by Poirier. The patent granted to Poirier teaches a platform based on audio events on which can be built larger applications to solve problems of capturing and transcribing human conversations. U.S. Pat. No. 7,047,192 also explains and teaches that indexing, cataloging, editing, and searching audio is possible using a browser to find specific content within text which is then directly linked with the relative audio event. More specifically it describes how this patent can be used as a building block approach to provide functionality for real-time automatic speech recognition systems that a scalable from a single user to hundreds and potentially thousands of users having conversations.

### BRIEF DESCRIPTION OF THE DRAWINGS

The character of the invention, however, may best be understood by reference to one of its structural forms, as illustrated by the accompanying drawings, in which:

FIG. 1 is a diagrammatic representation of a speech recognition system embodying the principles of the present invention,

FIG. 2 is a diagrammatic representation of a speech recognition system embodying the principles of the present invention,

FIG. 3 is a diagrammatic representation of a speech recognition system embodying the principles of the present invention,

FIG. 4 is a diagrammatic representation of a speech recognition system embodying the principles of the present invention,

FIG. 5 is a diagrammatic representation of a speech recognition system embodying the principles of the present invention,

FIG. 6 is a diagrammatic representation of a speech recognition system embodying the principles of the present invention,

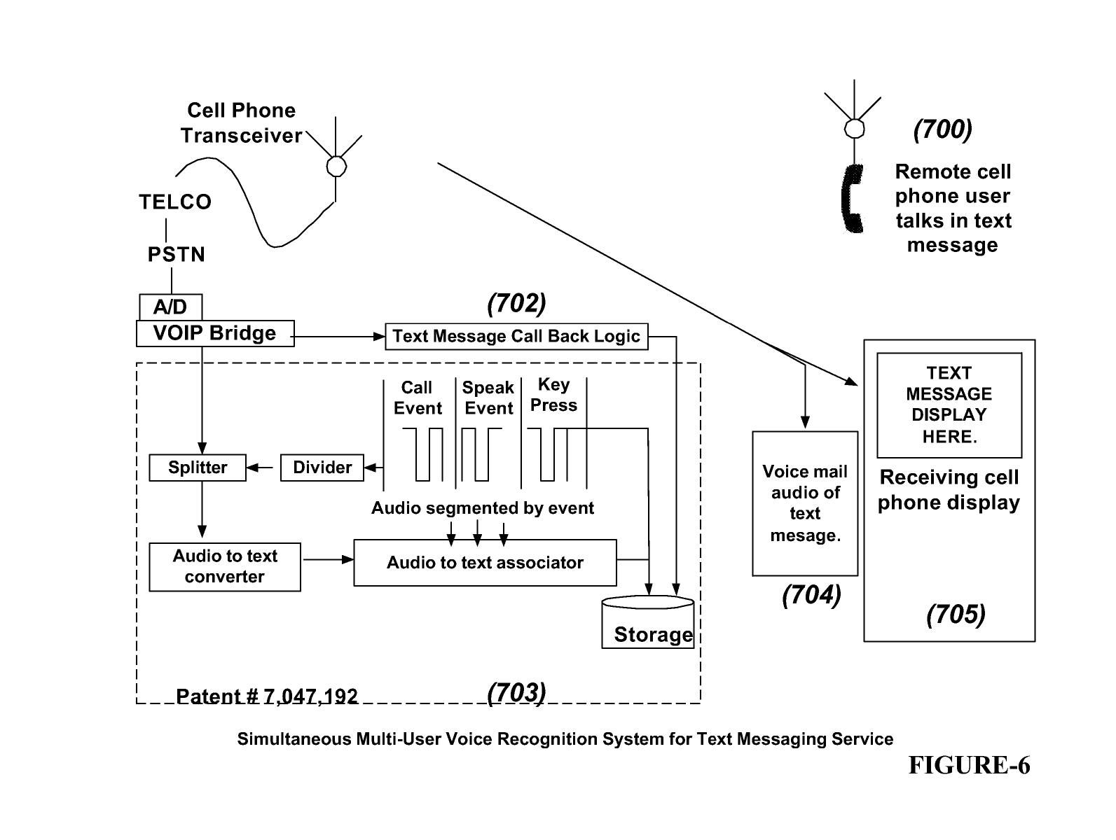

FIG. 7 is a diagrammatic representation of a speech recognition system embodying the principles of the present invention,

FIG. 8 is a diagrammatic representation of a speech recognition system embodying the principles of the present invention,

FIG. 9 is diagrammatic representation of a speech recognition system embodying the principles of the present invention, and

FIG. 10 is diagrammatic representation of a speech recognition system embodying the principles of the present invention.

### DETAILED DESCRIPTION OF THE INVENTION

The Poirier U.S. Pat. No. 7,047,192 describes a method and a system for providing automatic transcription of conversations from a single person or multiple people to create transcripts or notes. This paper brings forward examples of the many ways and technology that can be used to achieve a variety of systems based on Poirier's U.S. Pat. No. 7,047,192 including using the system for single person dictation, conference room conversation, telephone conference calls, telephone call recording device for bulk recording and information searching, and using the invention to construct indexing and cataloging of pre-recorded audio of human speech based on audio events. The following explains these configurations in more detail.

PSTN converted to VoIP for Recording, Transcription, Indexing, and Cataloging. Originally the public telephone system was based on PSTN which is well known throughout the communications industry. The PSTN system has minimal control when compared to the newer systems available like Voice over Internet Protocol or VoIP.

It is possible to connect a traditional PSTN telephone line to a VoIP bridge and apply that configuration to Poirier's invention U.S. Pat. No. 7,047,192 to gain additional functions and features. Also a VoIP based system is more compatible with computer technology and allows interfacing to software for controlling a system as Poirier has taught.

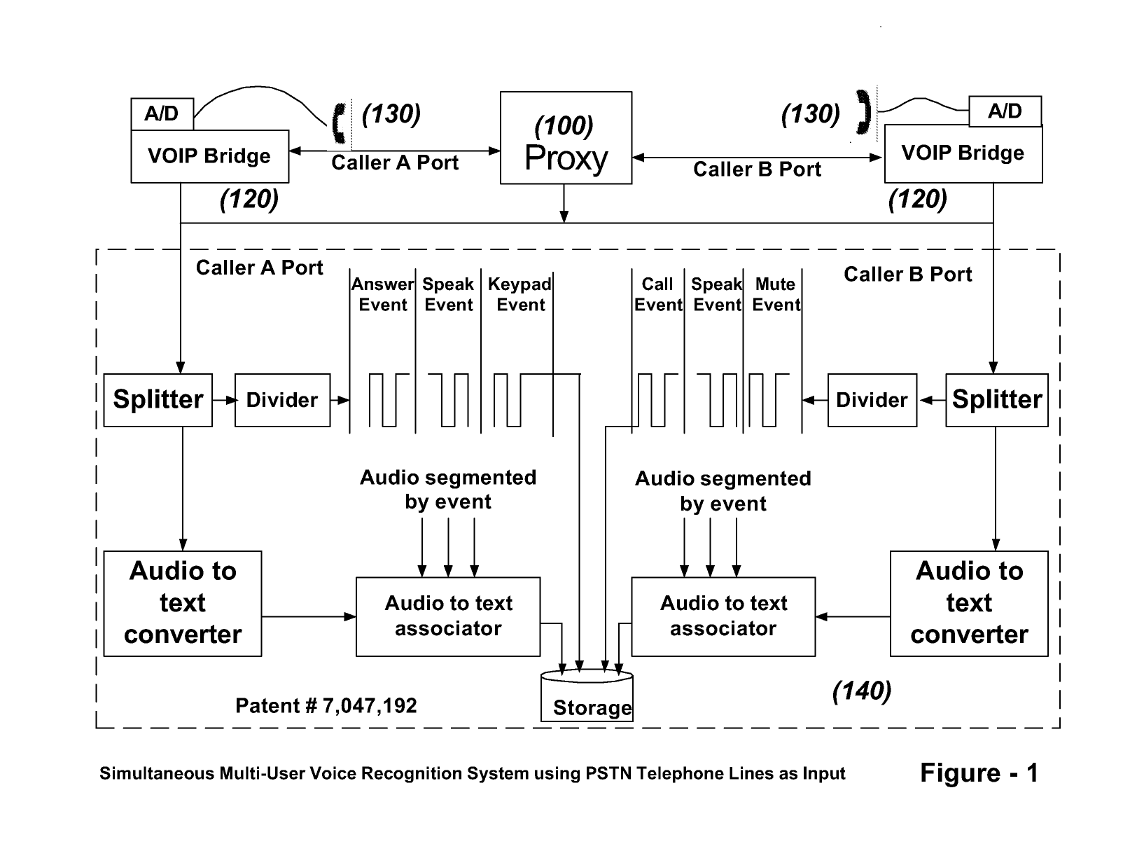

FIG. 1 shows a method of such a configuration. The PSTN telephone line (130) is connected to a VoIP bridge (120). The voice-over-IP bridge is controlled through a network connection by a communications proxy using Session Initiated Protocol or SIP which is commonly used and readily available in Voice-over-IP technology. After the proxy connects the caller(s) audio communication is engaged, the audio streams are provided as input to Poirier's invention (140) to create a Multi-user Voice Log being a text transcript with direct relationship to the recorded audio based on the call events. Using telephones with Poirier's invention is scalable from a single user to hundreds or even thousands of users. The user's audio may share a common network port but more desirable is to have each user's audio on a separate network port allowing each user to be easily separated in the MVL file creating a tag name for each user in the call.

FIG. 1 illustrates a graphic representation of this described system.

The bottom section of the graphic (140—bottom dotted line box) illustrates Poirier's invention U.S. Pat. No. 7,047,192 configured as a Multi-user Voice Log Recorder or MVLR. The MVLR contains the functional components that create the recording, the speech recognition function, and the event logic (Voice Time Integrator, Index Control and Events Capture) which actively communicate with the proxy which monitors and controls the state of the call in progress. Additional callers could be added to the call through additional SIP connections. An alternative configuration would be to use VoIP from end to end obviating the need for the local PSTN to VoIP bridges.

Computer Conferencing including Recording, Transcription, Indexing, Cataloging. Another alternative interface would be to use personal computers with microphones and speakers or computer headsets. The microphone and speaker connect to a sound device that provides the audio analog-to-digital conversion (not shown in this picture since it is very well known by anyone that uses computers). In each computer to be connected, software is installed that provides the functions of Poirier's invention U.S. Pat. No. 7,047,192. In this example 2 PC's are shown (201) and (202). The users would make a logical connection over a communications network like a LAN or WAN (200) either using a logical network address, user name, or telephone number. Once the VoIP call is connected Poirier's invention U.S. Pat. No. 7,047,192 on each computer (203) and (204) can create the Multi-user Voice Log from the incoming audio streams. Poirier, Hanegraaff, and Poirier constructed such a system that has been demonstrated is available for purchase. This referenced system is capable of real-time automatic speech recognition providing an instant transcript at all user locations instantly. The text is directly relative to the audio statements (events) of the conversation in the Multi-user Voice Log. Another alternative is to post process the audio events using speech recognition at a later time.

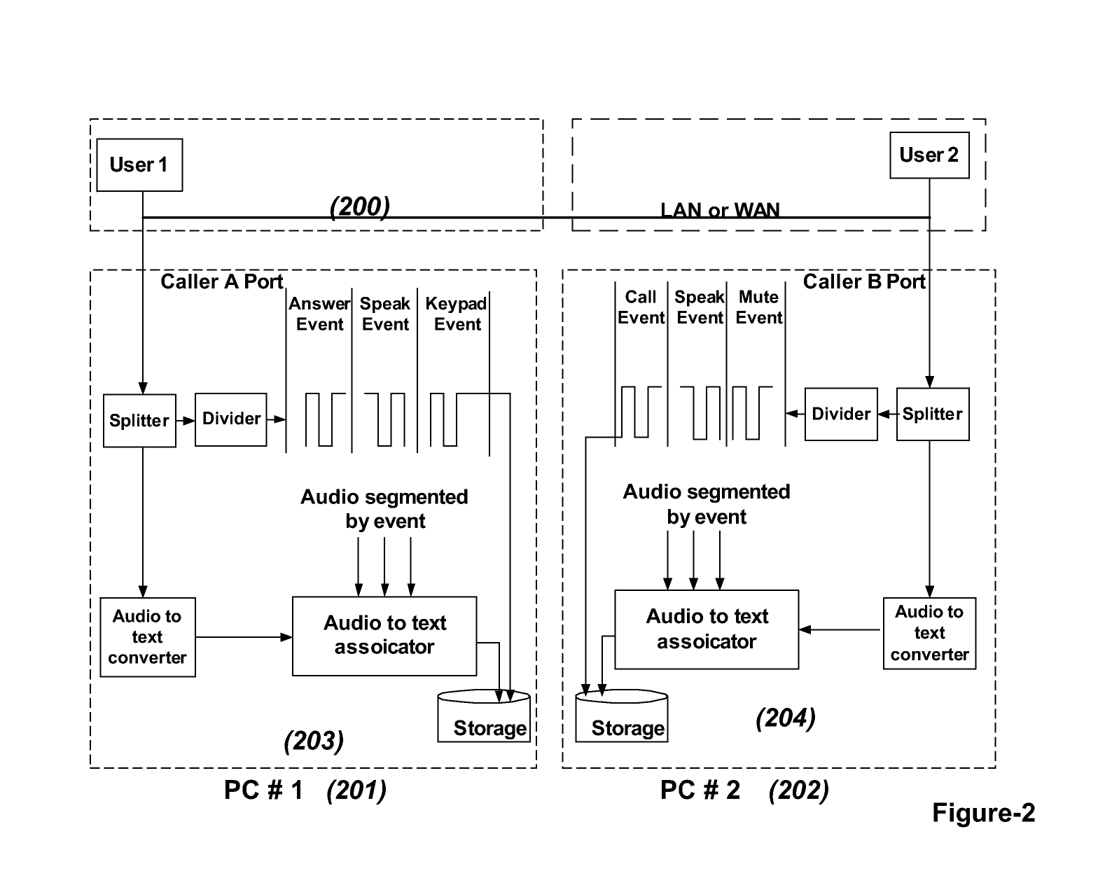

FIG. 2 shows the system in overview. This example shows 2 users, but it is not intended to limit to two users and in fact can have multiple users.

Single Telephone Interface for Remote Dictation. In yet in a different configuration of Poirier's U.S. Pat. No. 7,047,192 it is possible to use a single telephone input device (land line telephone, VoIP, cellular phone, or Internet connection) for the purpose of remote dictation to a personal computer at the user's home office or, as a dictation service. One example of how such a system would operate would be to have a user call a system, speak a subject line of the dictation (based on a single event), then follow up with the dictation (including multiple audio events) and, after the dictation is completed an e-mail of the transcript sent to the users email and/or emails of other people. This would result in the user getting an email message with a subject line of the dictation, the actual dictated text, and an attached audio file of the person's dictation or a hyperlinked location where the audio file can be downloaded from. An advantage of such a system would be that the user could then use email for indexing, sorting, and searching for specific dictated information. Another alternative is to have an MVL file available that the user can use with the MVL Browser tool.

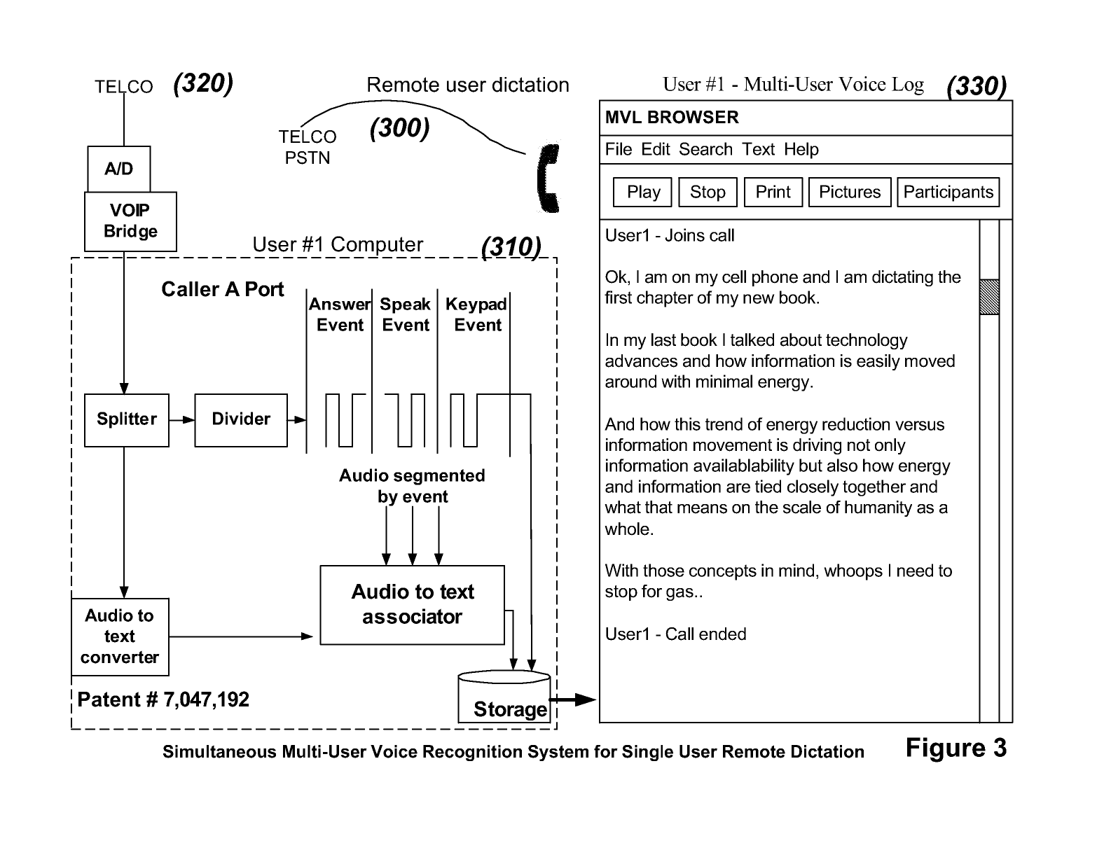

FIG. 3 illustrates that the remote user makes a telephone call to the public telephone system (300) which is connected to the user's personal computer (310) at a separate location. The computer which has software running that provides the function of Poirier's invention U.S. Pat. No. 7,047,192 with the MVLR and Proxy answers the phone through a voice-over-IP bridge (320) and instructs the user that the system is ready for dictation input. Poirier's invention is capturing and recording the audio events as the user provides dictation. There may be other events taking place as well like DTMF telephone tones allowing the user to take specific actions like pausing the recording or playback audio event for example. When the dictation is completed the user hangs up the phone. The dictated file is then at the user's PC when the user arrives back at the office for viewing and editing using the MVL Browser tool (330) or typical word processing software (not shown here). Alternatively the dictated files could be e-mailed for pickup at another location.

To further define a hosted system that could be used as a business to provide dictation services based on Poirier's U.S. Pat. No. 7,047,192, this is a system that provides an alternative method of operation from what is presently available in the market. In this example a user calls the dictation system and enters information in a specific sequence or responds to voice prompts. For example: 1) the user calls the dictation system, 2) the dictation system answers the call and ask the user to enter a personal access number, 3) the user enters the access number and then is instructed to dictate a subject line or index line for the information to be dictated (1 event), 4) the user speaks the subject line, for example: Business Opportunity at Acme Company, 5) the user is then instructed to dictate the body of the message (multiple events), 6) the user dictates and on completion hangs up the phone. 7) the dictation system then takes the 1^{st} event, transcribes it to text using speech recognition, and then inserts that text into an email subject line, 8) the dictation system then takes the dictated audio events, transcribes them using speech recognition and inserts the text events into the body of an email message. 9) the dictation system then links the audio events into a single file and inserts an audio recording (preferably compressed format like MP3) into the email message as an attachment or alternatively provides a link to download the audio from, and 10) the email is then sent using a predefined email address or to email addresses selected as part of the user login process either through speech prompts or speech input events.

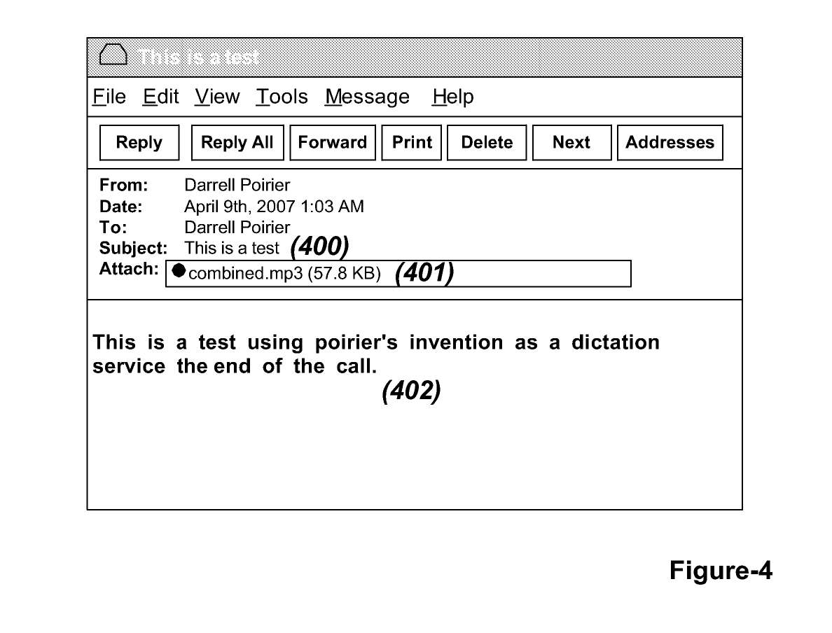

FIG. 4 illustrates the email with a subject line (400) and an MP3 audio file (401) of the combined events, and the text created from the dictated audio events (402) in the body of the email message. This figure is an actual email sent from the invention.

In yet another version of this host base system/service is the ability to have multiple users being recorded on a central conferencing system. Similar to the dictation service as described, the conferencing system allows many users to be connected simultaneously and conduct a telephone conversation, meeting, or teleconference. The system creates events for each user speaking and transcribes the events into text with relative links to the recorded audio. A transcript is the generated by putting the events into chronological order as they occurred. It is also possible to sort the events by subject matter creating a linked content for a specific subject with hyperlinks to the relative audio. As one example a system operates in this fashion: 1) each user calls the dictation system (which is running software to execute Poirier's invention including the Proxy and MVLR, 2) the dictation system answers the call and ask the user to enter an access number, 3) upon entering the access number each user is connected into the conference, 4) as the conference takes place, each user's comments are separated into events as described in Poirier's U.S. Pat. No. 7,047,192, 5) on completion of the audio meeting, the events are put into a Multi-user Voice Log also called an MVL also described in Poirier's patent, and 6) the users are then billed by time usage or number of calls or some other measurement.

Conference Room Interface. In Poirier's original patent he described The Simultaneous Multi-User Real-time Voice Recognition System as being able to support creation of a transcript in a conference room environment.

In this example of Poirier's invention each user in the conference room has a microphone to speak into and an optional head set or an earpiece for each speaker. The headset could be used for real-time language translation of the events or simply be used for the purposes of enhancing the audio. As the users speak into the microphones the audio stream is provided as input to Poirier's invention which then creates the Multi-user Voice Log.

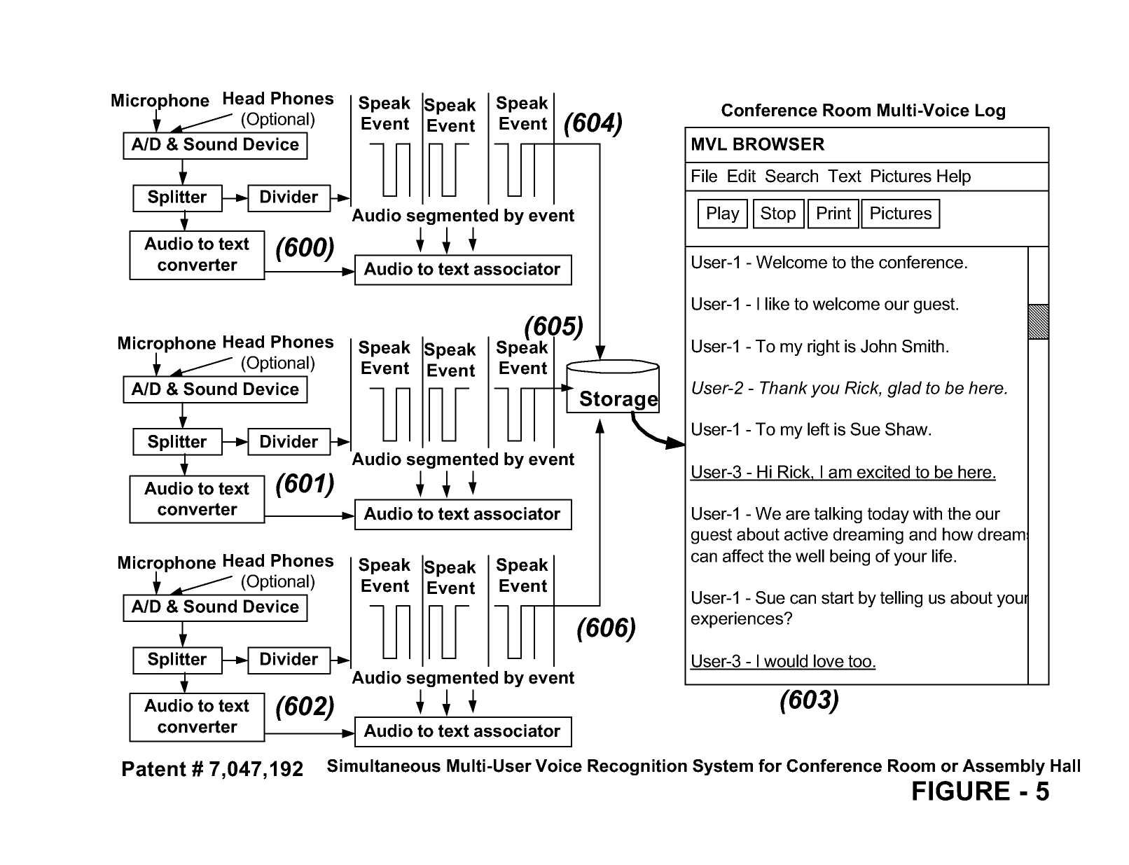

FIG. 5 shows a system to support three users however the system is not limited to three users. The microphone and headphone inputs are seen on the left (600), (601), (602) and the voice text transcript (Multi-user Voice Log) (603) output can be seen on the right. Each user's audio stream is functionally put through Poirier's invention U.S. Pat. No. 7,047,192 as depicted by (604), (605), and (606) in parallel or alternatively in a buffered sequential fashion not shown here. The system illustrated here represents a single computer system using Poirier's U.S. Pat. No. 7,047,192 to accomplish the task. It is also possible to user multiple computer systems (for example notebook computers) with the Computer Conferencing system as described previously to accomplish the task.

Interface and System for Automatic Text Messaging. Using cellular phone keypads to enter a text messages is very cumbersome due to a single button representing multiple letters on each of the numbers. In this version of Poirier's invention the system uses a telephone or a cellular phone as the voice audio input string to ultimately provide a text message on a telephone display. In overview the system would basically operate like this, the user receives a text message on their cell phone and would like to respond. The user through voice commands would place a telephone call (700) to a computer that has a Simultaneous Multi-User Real-time Voice Recognition System installed (703). On completion of the user's voice input, the user hangs up the phone. The Simultaneous Multi-user Real-time Voice Recognition System would then take action on the hang-up event signaling to a new function called the Text Message Callback Logic (702) to dial the telephone number of the cell phone where the text message is to be sent and then provide the text message (705) made up of text-audio events as described in Poirier's U.S. Pat. No. 7,047,192 to be displayed on the destination cell phone's display screen. An additional advantage is the audio can be sent to the receiver's voice (704) mail in parallel to allow the receiving party the ability to have both the text message and the voice mail as reference. This method would allow the receiver to have the ability to overcome any accuracy errors with the speech recognition.

This option could be sold by telephone companies as a service or a software application could be loaded on a personal computer to provide the function. The advantage on using an event system as described by Poirier is that the relative audio can be delivered to voice mail along with the text message allowing the user a choice of medium as well as storage of the information.

Voice Mail to Text. The normal method for communicating with people via telephone when a person is not available is to leave a voice mail. Voice mail may not be the best alternative for the person receiving the message for many reasons for example; a) the person receiving the voice mail cannot hear the audio due to loud background noise, b) the person is in a situation where it is not socially acceptable to listen to voice mail like a class room, or c) the person may not have a device at hand where audio is available. In any case to supply only one form of voice mail review is a disadvantage.

Adding additional components to Poirier's U.S. Pat. No. 7,047,192 creates new options where the invention can be used as a telephone answering machine that provides alternative review features for both audio recording for the voice mail and electronic text or physical document output, or a combination of both. In this configuration a user would call a destination phone number that would directly connect to a Simultaneous Multi-User Voice Recognition System.

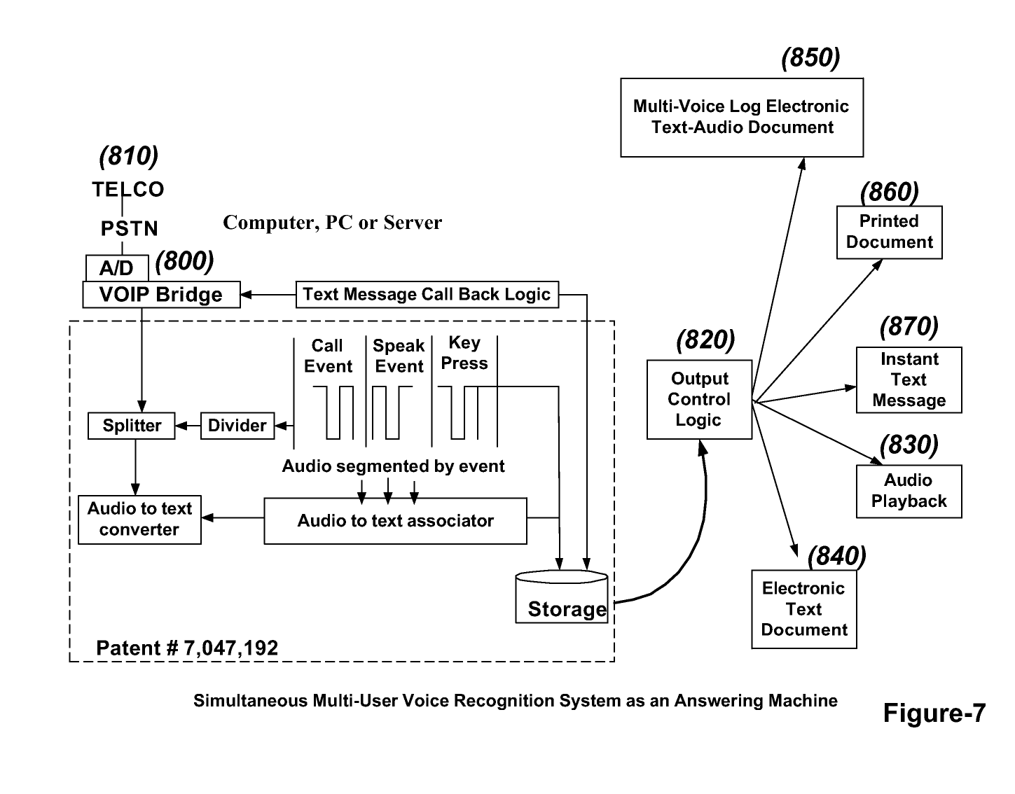

Referring to FIG. 7, new components to create a system would include a VoIP bridge (800), a telephone (810), and output control logic (820) to send the preferred option to a specific medium presentation type. The telephone call would be answered by telephone connection logic, for example a SIP based voice-over-IP bridge controlled by SIP proxy software. Once the call connection is established, the audio stream is fed to Poirier's invention for event recording and speech recognition of the events. Poirier's invention can provide various forms of output including: 1) audio recording (830), 2) electronic text document (840), 3) MVL text-audio electronic document (850), 4) printed text document (860), or 5) A text message (870) on a handheld personal computer or cell phone.

The output control logic (820) is a combination of software and software configuration, device drivers, and devices. For example if the desired output printed text, during the setup/configuration process the options for printed output and printer would be selected. Upon completion of the call end event (caller hangs up the phone) trigger a software script or executable code would merge the transcript text, submit it as a print job that gets passed to the printer device driver which then send the text to the printer buffer and then gets printed.

As another example, if the desired output is a text-audio MVL document, then that option would be selected in the setup and configuration. Then upon completion of the call end event, a software script or executable code would create the Multi-user Voice Log by taking creating MVL control data linked to time stamped events that are linked to text which is linked to relative audio events.

As the last example, if the person wants to receive a text message of the voice mail on a handheld computer or telephone, then this option would be selected during the configuration. Upon completion of the call end event, a software script or executable code would then take the text and combine it into a single message to provide to a Short Message Service or SMS. The SMS software now has an option where it can break apart the text message into smaller sections of 160 characters if 7-bit coding is used for example, or another alternative is the SMS software could use Concatenated SMS Messages, but in either case someone skilled in this area would clearly understand the standard protocol of software coding for the various SMS options of which there are more than mentioned here. The voice mail text is then displayed on the handheld device using SMS. Additionally the audio can also be delivered to the user's voice mail system to have the option of having both the voice and text.

In all the examples above, having the ability to use events as described by Poirier's U.S. Pat. No. 7,047,192 creates new options for Voice Mail to Text based on taking actions when specific events take place allowing users options that can fit various specific situations.

Network Audio Monitor. It is common practice for companies and individuals to record and monitor telephone conversations and other communications for training, compliance, informational search, and other various reasons. A common problem with capturing audio information is finding specific information buried in audio files. Poirier's teaches a method of creating events from audio streams and being able to index into audio by searching text that is relative to an audio event.

Poirier's patent can also be used for bulk recording of audio conversations by monitoring VoIP traffic on a local area network (LAN) or a wide area network (WAN). Telephone conversations routinely travel over networks in the form of VoIP or RTP packets. It is a common practice of network tracing software and equipment to be attached to a network point and then as TCP/IP or packets of other protocols travel from point to point, to copy the packets to a 3^{rd} device or software for the purposes of examination. For VoIP it is possible to “listen in” on the RTP stream. In this way a copy or a recording of an audio stream can be generated. Using this process with Poirier's U.S. Pat. No. 7,047,192 allows the audio stream to be supplied to an MVL Recorder. In some cases it may be necessary to include encryption-decryption technology with this model.

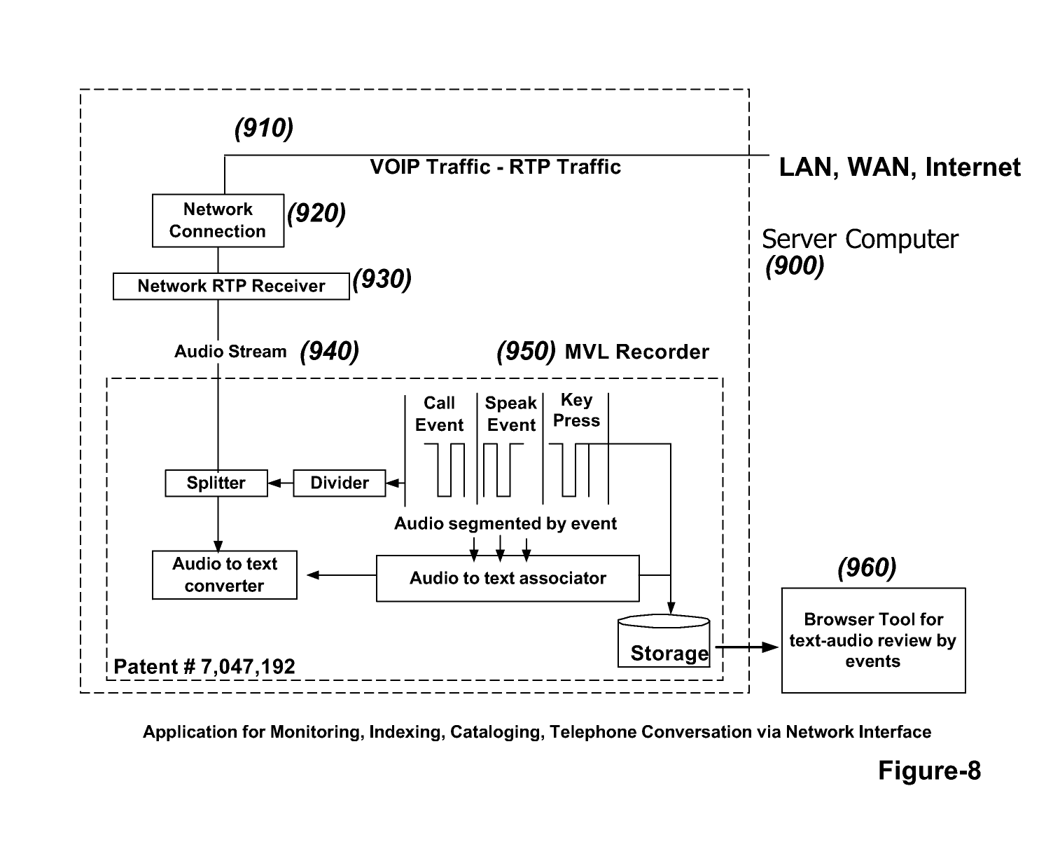

Referring to FIG. 8, a server computer (900) with a network connection (920) is attached to a network (910) where RTP audio stream transfer is occurring. The server computer “listens in” on the RTP audio stream using a passive network RTP receiver (930) using a specific port ID or other identifier. The audio stream is then passed to Poirier's U.S. Pat. No. 7,047,192 where text-audio events are used to create a Multi-user Voice Log as previously described. The MVL Browser (960) is then used to examine the Multi-user Voice Log.

Indexing, cataloging, search and data mining. There are audio libraries throughout the world with large collections of audio files. And more audio is being captured everyday by recording telephone conversations, meetings, dictation, audio books, panel discussions, classroom lectures, the list of why recordings is massive. All these audio files have a common problem, and that is finding specific information within an audio file while keeping the information in the “context” of the conversation. There are some techniques that employ methods of indexing every word in audio with a relative text word and an index from the beginning of the audio to a specific word. A common problem with this method however, is that the word is not put in context of the spoken event from when the word occurred. Poirier's U.S. Pat. No. 7,047,192 solves the problem of keeping the words in context because when a word is searched in text it is linked to the audio event of when the word was spoken relative to the context of the content. A secondary problem exist where non-relative audio files may have relative information, however the information is not linked, nor is the content linked.

To solve this problem Poirier's original teaching can be taken a step further to using text-audio events to construct a knowledge base. More specifically audio-text events can be used as packets of information and stored as a multi-dimensional knowledge base providing the ability to find related information in audio files that span time.

This also provides new relative information discovery and creation of yet new information based on text-audio events from multiple sources potentially providing the ability to copyright audio and text materials as new works adding new value to old information.

Present day speech recognition technology is not an exact science, therefore, other methods to enhance the audio search and indexing capability can be used to increase search capabilities, for example, using rimes. Voice recognition in some cases will transcribe a word in error using a word that sounds similar or rhymes with the correct word, for example “phone” and “home”, or “text” and “tax”. In many cases the same words in error will reappear fairly consistently and thus can be incorporated in an index and search algorithm to increase the accuracy of searching for specific information in audio.

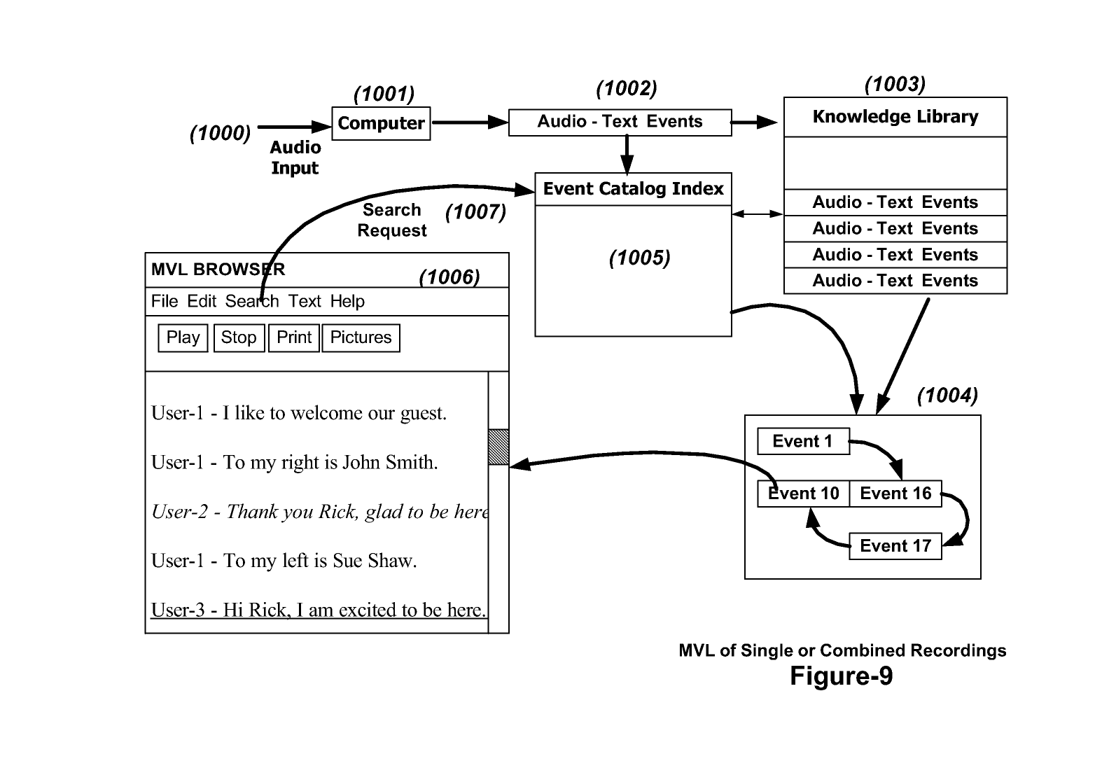

Referring to FIG. 9, an audio stream is fed to Poirier's invention U.S. Pat. No. 7,047,192 through tradition audio feeds, for example a microphone, telephone, or previously recorded audio file (1001). The process as described by Poirier's teaching in U.S. Pat. No. 7,047,192 creates audio-text events (1002).

It is then possible to create a knowledge base (1003) that is indexed (1004) and cataloged (1005). The MVL Browser tool (1006) can then be used to execute search queries (1007) to find specific information within the knowledge base (1003) based on the event catalog (1005) for general level content, and then the index (1004) more specific or exacting information. The information is then transferred (1008) and presented in the MVL Browser (1006) as a list of relative events.

The MVL Browser tool provides a reproduction of each relative audio event as they had taken place providing an enriched presentation of the human interaction and conversations. It brings together a presentation of audio and text within the context of how the content of the conversations occurred.

The MVL Browser can also have filtering features to show event of, for example, a specific speaker, specific content, short duration statements, specific words, etc. It also has the ability to print, play audio, play event, edit, and delete events.

Or alternatively, the MVL could be configured as an un-alterable electronic document with encryption for digital type signatures using standards like MD5 or DES or some other method basically creating a tamper proof MVL text-audio electronic document which can be used as a legal record.

Audio editing. Another usage for Poirier's U.S. Pat. No. 7,047,192 is to use the event based system as an audio editor. Indexing is a common problem when trying to edit audio recordings from telephone calls, teleconferences, and microphone based audio files, and audio from video files. The reason being is that the most common index used is based on time. However the time index in audio editors can drift or may not consistently start at the same location relative to a specific point in the audio file itself. As a result, a common problem is that when a section of audio is to be deleted, copied, or modified, the edit may be slightly too early or too late causing multiple edit attempts wasting time and labor resources. Using and editing tools based on Poirier's invention U.S. Pat. No. 7,047,192 provides an advantage because all audio is divided into events making it easy to delete a specific event without the need for an audio editor. Moreover a simple editing feature can be added to the MVL Browser or a different tool where an unwanted event can be deleted or copied for example without the need for an additional indexing method potentially saving hours when compared to previous methods available.

In yet another way Poirier's invention can be used is for locating specific information within audio content. It is commonly known that speech recognition applications can be used to search for keywords or phrases within audio content. There is a problem with the present models because when keywords are located, the commonly used indexing method is time index. Time index can locate a specific word, however it does not have the ability

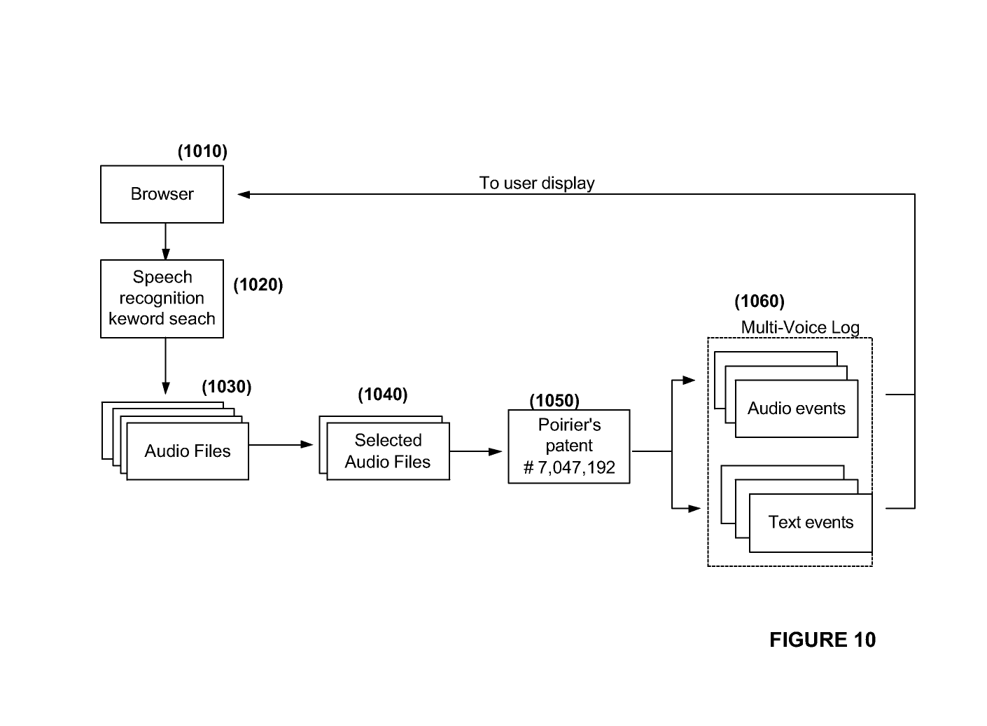

to display the word or phrase within context except to add some arbitrary amount of time prior to and after the keyword located. Using Poirier's invention U.S. Pat. No. 7,047,192, the event(s) where the word or phrase is located can be displayed keeping the target word in context. Moreover, to reduce processing time it would be possible to search for keywords or phrases prior to converting an audio file to an event based format. Then after specific words are located in specific audio files, then convert those target files only to event based as taught by Poirier U.S. Pat. No. 7,047,192 and then display only the events with the targeted searched information. Referring to FIG. 10, the user makes a search request from a browser or other software application (1010) to speech recognition software (1020). Using the speech

recognition search for reading audio files (1030) specific audio files (1040) are selected that contain the target search keywords. The selected audio files are then processed using Poirier's invention U.S. Pat. No. 7,047,192 (1050) to create the Multi-Voice Log files (1060) as described by Poirier. The relative events based on the target search criteria are then displayed back to the browser (1010) for the user.

It is obvious that minor changes may be made in the form and construction of the invention without departing from the material spirit thereof. It is not, however, desired to confine the invention to the exact form herein shown and described, but it is desired to include all such as properly come within the scope claimed.

The invention having been thus described, what is claimed as new and desire to secure by Letters Patent is:

1. An enhancement of the speech recognition system described in U.S. Pat. No. 7,047,192.

2. A system as recited in claim 1, wherein a telephone call automatic transcription or indexing system specifically using Poirier's U.S. Pat. No. 7,047,192 using VoIP telephone systems.

3. A system as recited in claim 1, wherein A network based transcription or indexing system specifically using Poirier's U.S. Pat. No. 7,047,192 using personal computers as input and output devices where the audio and relative text transcripts are provided to all user locations or a central location.

4. A system as recited in claim 1, wherein a single user telephone dictation system specifically using Poirier's U.S. Pat. No. 7,047,192 and a telephone connection that calls a computer system running software that executes code to perform the tasks taught in Poirier's U.S. Pat. No. 7,047,192.

5. A system as recited in claim 1, wherein a hosted business model specifically using Poirier's U.S. Pat. No. 7,047,192 for a remote dictation or indexing service where users pay a per-call, per-minute, or monthly fee for service usage.

6. A system as recited in claim 1, wherein a hosted business model system specifically using Poirier's U.S. Pat. No. 7,047,192 for a telephone call transcription or indexing services where users pay a per-call, per minute, or monthly fee for service usage.

7. A system as recited in claim 1, wherein a conference room product specifically using Poirier's U.S. Pat. No. 7,047,192 where the product is provided to companies that use the product for the purposes of providing on site transcription or indexing services.

8. A system as recited in claim 1, wherein a text messaging service specifically using Poirier's U.S. Pat. No. 7,047,192 where spoken audio is used as the input to a device and the text events are used to take specific actions including sending SMS messages and inserting specific text, graphics, or numbers to a target cell phone or hand held computer.

9. A system as recited in claim 1, wherein a text messaging service specifically using Poirier's U.S. Pat. No. 7,047,192 where spoken audio is sent to a target user's voice mail.

10. A system as recited in claim 1, wherein a voice mail to text product or service specifically using Poirier's U.S. Pat. No. 7,047,192 where the output of the system from a person leaving voice mail, is to provide text in the form of an electronic document, printed document, or SMS text message.

11. A system as recited in claim 1, wherein a telephone call monitoring server specifically using Poirier's U.S. Pat. No. 7,047,192 where telephone calls are recorded using a passive network RTP listening method resulting with the audio-text event information that can be search him ed and reviewed.

12. A system as recited in claim 1, wherein a search, index, and cataloging method specifically using Poirier's U.S. Pat. No. 7,047,192 where each event is indexed and cataloged for searching, sorting, filtered, edit, printed, audio playback, exporting, and events presented using an MVL Browsing tool.

13. A system as recited in claim 1, wherein a Multi-user Voice Log that is an unalterable single file that is digitally encrypted and signed using MD5, DES, or other method to ensure that the specifically a Multi-user Voice Log file has not been changed from its original state.

14. A system as recited in claim 1, wherein a method of adding sound alike words and rhymes to indexes for the purpose of increasing audio search accuracy specifically using Poirier's U.S. Pat. No. 7,047,192 where each event is indexed and cataloged for searching, sorting, filtered, edit, printed, audio playback, exporting, and events presented using an MVL Browsing tool.

15. A system as recited in claim 1, wherein a method of editing audio files by event specifically using the event format as taught in Poirier's U.S. Pat. No. 7,047,192 where an audio event can be added, deleted, copied, imported, exported, or modified.

16. A system as recited in claim 1, wherein a data analysis tool based specifically based on Poirier's U.S. Pat. No. 7,047,192 where statistics can be gathered on a library or collection of events and displayed in the form of charts, graphs, counts of specific information for the purpose of illustrating trends or patterns of behaviors.

17. A system as recited in claim 1, wherein an audio search method using speech recognition to locate keywords or phrases in audio file(s), then converting audio files that contain the target keywords to events specifically using Poirier's teachings in U.S. Pat. No. 7,047,192, and then displaying the relative text-audio events as the
search results.
